(19) United States
(12) Patent Application Publication
(10) Pub. No.: US 2019/0376639 A1
(43) Pub. Date: Dec. 12, 2019

(54) HEIGHT-ADJUSTABLE DISPLAY SUPPORT

(71) Applicant: Innovative Office Products, LLC, Easton, PA (US)

(72) Inventors: Stephen J. Bowman, Saylorsburg, PA (US); Michael Paul Erney, Whitehall, PA (US); Eric Andrew Schultz, Walnutport, PA (US); Alexander James Sinton, Doylestown, PA (US)

(73) Assignee: Innovative Office Products, LLC, Easton, PA (US)

(21) Appl. No.: 16/434,824

(22) Filed: Jun. 7, 2019

Related U.S. Application Data
(60) Provisional application No. 62/683,156, filed on Jun. 11, 2018.

(51) Int. Cl. F16M 11/04

(52) U.S. Cl. CPC F16M 11/046; F16M 11/08

(57) ABSTRACT

A height-adjustable display support is disclosed in which a carriage is fixed at a stationary elevation with respect to an external support surface, and a column is height-adjustable with respect to the carriage to change the height of a display attached to the column. In some embodiments the carriage is supported by an arm that is not height-adjustable.

### BACKGROUND

Articulating arms for supporting electronic devices (e.g., computer monitors) are well known in the art. These devices typically employ an internal extension and retraction device, for example a coiled spring or gas spring, to counterbalance the weight of the attached device while permitting the arm to be height-adjustable. Such extension and retraction devices are expensive and prone to failure after repeated cycling of the arm. They are also large and therefore provide design constraints to the inventors of these products.

Accordingly, there is a need for improved height-adjustable device supports that address these and other shortcomings of the prior art devices.

### BRIEF DESCRIPTION OF THE DRAWINGS

The present disclosure will hereinafter be described in conjunction with the appended drawing figures, wherein like numerals denote like elements.

FIG. 1 is a front perspective view of a height-adjustable device support in accordance with an embodiment of the present disclosure;

FIG. 2 is a rear perspective view thereof;

FIG. 3 is a front perspective view of an arm portion thereof with arm covers removed;

FIG. 4 is a front perspective view of a lift portion of the height-adjustable device support of FIG. 1;

FIG. 5 is a rear perspective view of a display support assembly thereof;

FIG. 6 is a rear perspective view of portions of the lift portion of the height-adjustable device support of FIG. 1;

FIG. 7 is an exploded view of portions of the lift portion;

FIG. 8 is a perspective front view of portions of the lift portion;

FIG. 9 is a partial exploded view of portions of the top end of the lift portion;

FIG. 10 is a perspective view of portions thereof;

FIG. 11 is a perspective side view of portions of the lift portion;

FIG. 12 is a perspective front view of portions of the lift portion;

FIG. 13 is a rear perspective view of portions of the lift portion;

FIG. 14 is a front perspective view of portions of a handle assembly of the lift portion, in an unactuated configuration;

FIG. 15 is a front perspective view thereof, in an actuated configuration;

FIG. 16 is a sectional view taken through line 16-16 of FIG. 8, while the handle assembly is in its unactuated configuration;

FIG. 17 is a sectional view taken through line 17-17 of FIG. 8, while the handle assembly is in its actuated configuration;

FIGS. 18A-18C shows side views of a height-adjustable device support in accordance with an alternative embodiment of the present disclosure, in various configurations; and

FIG. 19 is a front perspective view thereof.

### SUMMARY OF THE INVENTION

In one respect, the present invention is a height-adjustable device support comprising a lift portion, the lift portion including a carriage adapted to be supported from a support surface at a stationary vertical elevation with respect to the support surface; a column attached to the carriage, the column having a height; at least one display support assembly attached to the column; and a release mechanism having an actuated state and an unactuated state, wherein when the release mechanism is in its unactuated state the height of the column is not adjustable with respect to the stationary vertical elevation of the carriage, and wherein when the release mechanism is in its actuated state at least a portion of the height of the column is adjustable with respect to the stationary vertical elevation of the carriage.

In another respect, the present invention is a height-adjustable device support comprising a carriage, the carriage being attachable to a support surface at a stationary vertical elevation with respect to the support surface; a column that is slidably attached to the carriage, the column having a height; a brake block fixedly attached to the carriage and located at least partially within the column; a brake cam located at least partially within the column; and a release mechanism having an actuated state and an unactuated state, wherein when the release mechanism is in its unactuated state the brake cam applies pressure against the brake block in a quantity sufficient such that the height of the column is not adjustable with respect to the stationary vertical elevation of the carriage, and wherein when the release mechanism is in its actuated state the brake cam applies reduced or zero pressure against the brake block, such that at least a portion of the height of the column is adjustable with respect to the stationary vertical elevation of the carriage.

In yet another respect, the present invention is a height-adjustable device support comprising an arm portion, the arm portion having a first end and a second end located opposite the first end, wherein the vertical elevation between the first end and the second end is fixed; and a lift portion, the lift portion including a carriage that is fixedly attached to the second end of the arm portion at a stationary vertical elevation with respect to the first end of the arm portion; a column attached to the carriage, the column having a height; at least one display support assembly attached to the column; and a release mechanism having an actuated state and an unactuated state, wherein when the release mechanism is in its unactuated state the height of the column is not adjustable with respect to the stationary vertical elevation of the carriage, and wherein when the release mechanism is in its actuated state at least a portion of the height of the column is adjustable with respect to the stationary vertical elevation of the carriage.

### DETAILED DESCRIPTION

The ensuing detailed description provides preferred exemplary embodiment(s) only, and is not intended to limit the scope, applicability, or configuration of the present disclosure. Rather, the ensuing detailed description of the preferred exemplary embodiment(s) will provide those skilled in the art with an enabling description for implementing the preferred exemplary embodiment(s) of the disclosure. It should be understood that various changes may be made in the function and arrangement of elements without departing from the spirit and scope of the disclosure, as set forth in the appended claims.

To aid in describing the disclosure, directional terms may be used in the specification and claims to describe portions of the present embodiment(s) (e.g., upper, lower, left, right, etc.). Unless specifically indicated, these directional definitions are merely intended to assist in describing the disclosure and claiming the invention and are not intended to limit the described disclosure or claimed invention in any way. In addition, reference numerals that are introduced in the specification in association with a drawing figure may be repeated in one or more subsequent figures without additional description in the specification in order to provide context for other features.

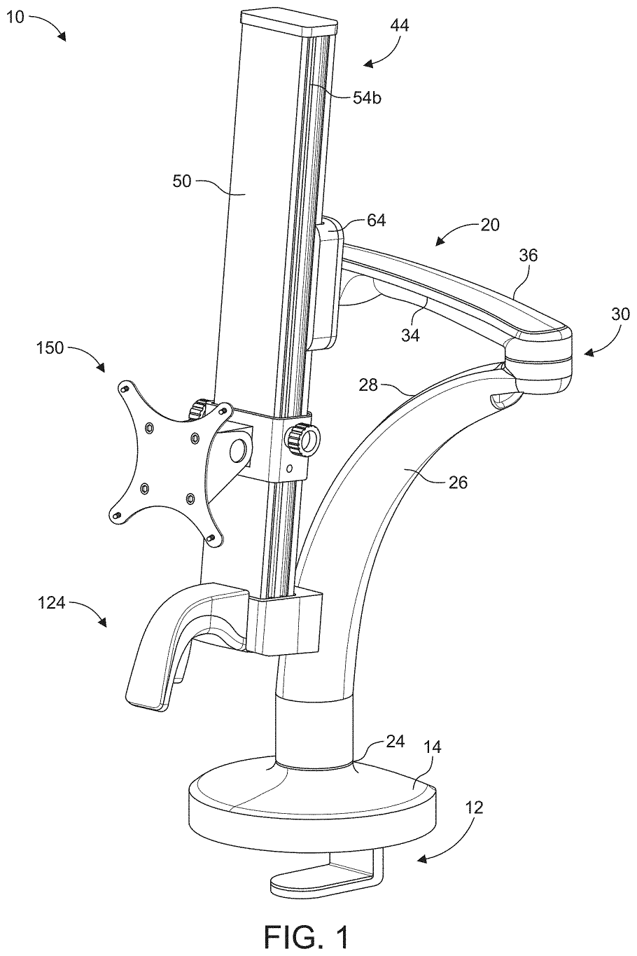

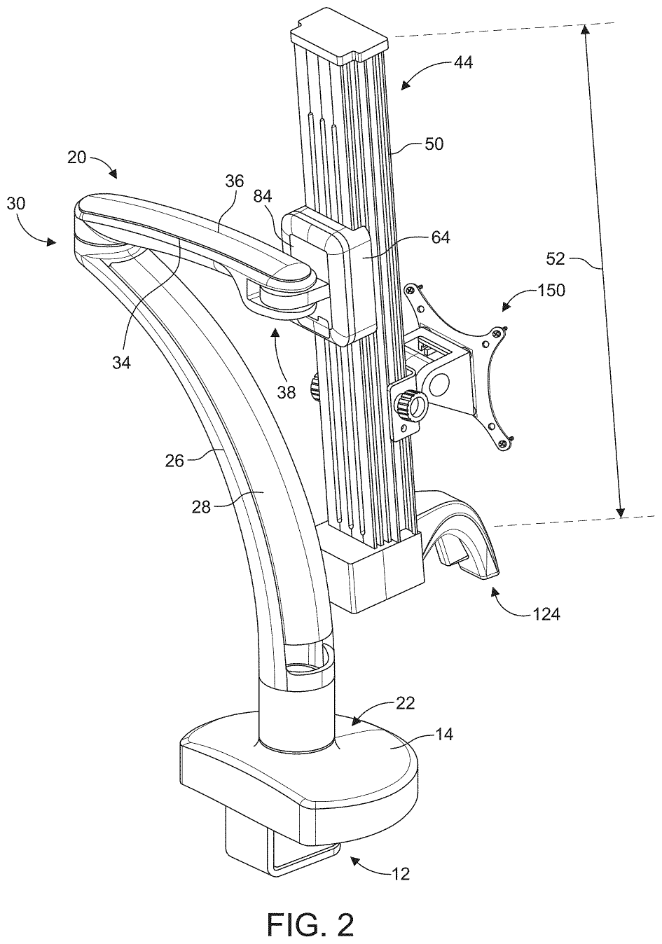

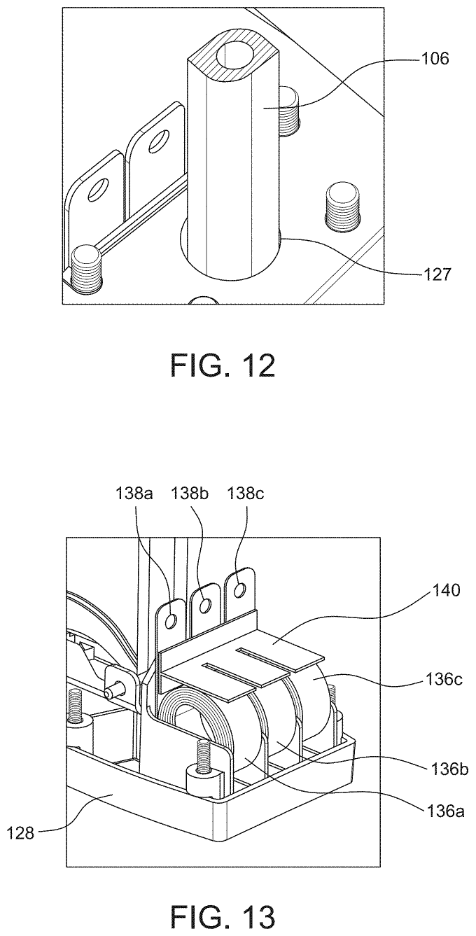

Referring generally to FIGS. 1-17, an embodiment of a height-adjustable device support 10 in accordance with the present disclosure is shown. In this embodiment, as shown in FIGS. 1 and 2, the device support 10 includes a base mount assembly 12 (e.g., a clamp) which is used to attach the device support 10 to a support surface (not shown), such as a table, desk, or other generally-horizontal surface. A base plate 14 is attached to the base mount assembly 12 and is adapted to rest atop the support surface. In alternative embodiments, the device support 10 could be attached to any support surface via any known or hereafter-discovered clamping or attachment means.

In this embodiment, the device support 10 generally comprises an arm portion 20 and a lift portion 44. In this embodiment, the arm portion 20 comprises a lower joint 22 where a main arm 26 is attached to the base plate 14, a middle joint 30 where the main arm 26 is attached to a forearm 34, and an upper joint 38 where the forearm 34 is attached to the lift portion 44. In this embodiment, each of the lower joint 22, middle joint 30, and upper joint 38 permit for rotation of the respective parts about a generally-vertical axis, although in alternative embodiments one or more of these joints could lack such rotational freedom. In the present embodiment, a rotation stop (not shown) is provided within the lower joint 22 so that the main arm 26 may rotate only through a range of approximately 180 degrees about the base plate 14, generally to prevent the arm portion 20 from extending behind a rear edge of the support surface. Greater or lesser rotational freedom at the lower joint 22 could be provided in alternative embodiments. In the present embodiment, there is also approximately 180 degrees of rotational freedom provided at the upper joint 38. Greater or lesser rotational freedom at the upper joint 38 could be provided in alternative embodiments.

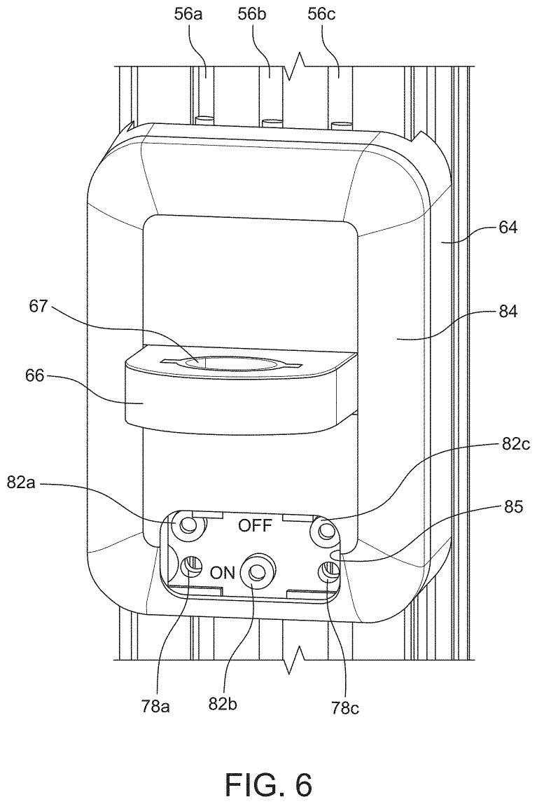

In this embodiment, a mount bushing 24 is located within the lower joint 22 to prevent metal-on-metal contact between the base plate 14 and main arm 26. The middle joint 30 comprises a joint shaft 31 and a surrounding bushing (not shown) that prevents metal-on-metal contact between the main arm 26 or joint shaft 31 and the forearm 34. Similarly, a joint shaft 40 is used at the upper joint 38, and a bushing 42 surrounds the joint shaft 40 to prevent metal-on-metal contact between the forearm 34 and a joint plate 66 of a carriage 64 of the lift portion 44. Further, the joint plate 66 of carriage 64 comprises an opening 67 (containing a bushing, shown in FIG. 6 but not labeled) that surrounds the the joint shaft 40 to complete the upper joint 38 by helping to avoid metal-on-metal contact between the joint plate 66 and the joint shaft 40. One or more of the above-noted bushings may be comprised of acetal, nylon, PTFE, or any other suitable material.

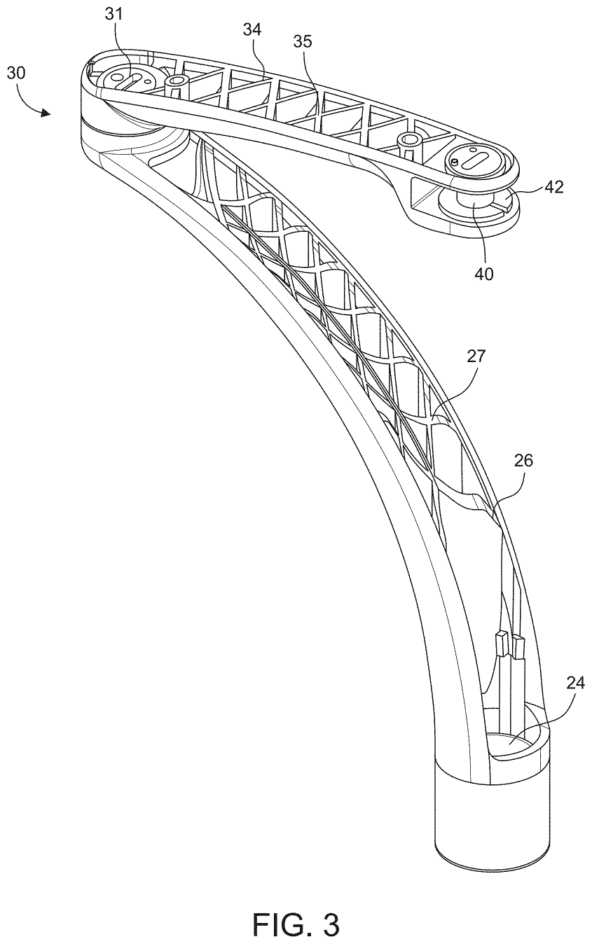

As shown in FIG. 3, in this embodiment the main arm 26 includes reinforcement ribs 27 and the forearm 34 includes reinforcement ribs 35 that provide the main arm 26 and forearm 34, respectively, with structural and torsional strength and stability while reducing the weight and materials usage of the arm portion 20. In this embodiment, respective covers 28,36 are used to conceal the respective reinforcement ribs 27,35. As will be discussed in greater detail below, in this embodiment the lift portion 44 provides all of the necessary height adjustability for the device support 10, while the main arm 26 and forearm 34 are rigid (i.e., non-height-adjustable) arms. This permits the arm portion 20 to be greatly simplified in embodiments of the device support 10 compared with prior art arms, thus reducing costs and allowing for greater design freedom for the components of the arm portion 20. Moreover, the use of rigid components in the arm portion 20 greatly reduces the amount of deflection in the arm portion 20 caused by attached masses as compared to known prior art articulating arms. The covers 28,36 may be provided in any color and with any desired surface pattern or ornamentation, to permit for aesthetic customizability of the device support 10.

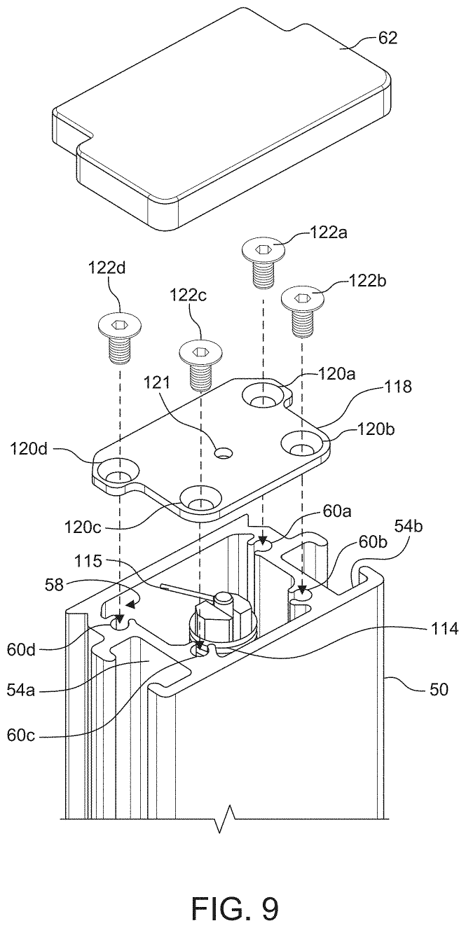

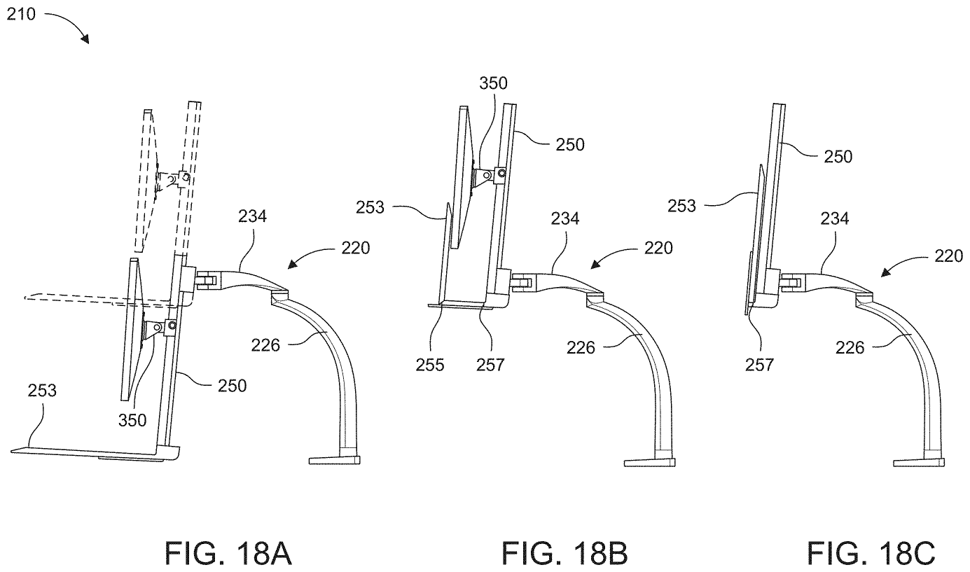

The lift portion 44 of the device support 10 will now be described in detail. In this embodiment, a column 50 having a height 52 is attached to the carriage 64 in a slidable relationship with respect to the location of the carriage 64, such that the column 50 may be moved upwardly and downwardly with respect to the fixed height location (i.e., a stationary vertical elevation) of the carriage 64 with respect to the relevant support surface (see, e.g., the two positions of the column 250 in FIG. 18A). In alternative embodiments, the length of the height 52 of the column 50 may be varied. The slidable relationship between the column 50 and the carriage 64 could be achieved—as in the present embodiment—via grooves in the extruded profile of the column 50 (see the grooves located behind the attachment slots 54a,54b in FIG. 9) that mate with extending portions located on the carriage 64 or—in alternative embodiments—the extruded profile of the column could be formed with extending bosses (which could be round) that mate with blocks that attach to the carriage (or are formed integrally therewith) and that slide with respect to the bosses.

Turning back to the embodiment of FIGS. 1-17, the column 50 has a pair of attachment slots 54a,54b located on either side thereof running along the height 52 of the column 50, for supporting of a display support assembly 150 from the column 50. In this embodiment, the display support assembly 150 comprises a tilter 154 for up-down angle adjustment (i.e., about a generally horizontal axis) of a display or other electronic device that is attached to the tilter 154 via an adapter plate 156, which in this embodiment includes multiple sets of mounting holes (not labeled) arranged according to standards set by VESA, as would be appreciated by those having ordinary skill in the relevant art. In alternative embodiments, the tilter 154 could be omitted. In further alternative embodiments, the adapter plate 156 could have any mounting hole pattern.

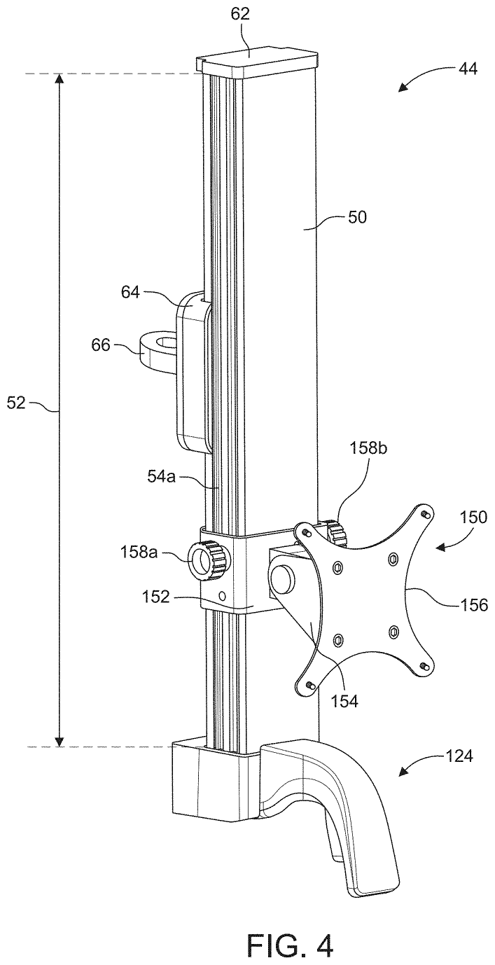

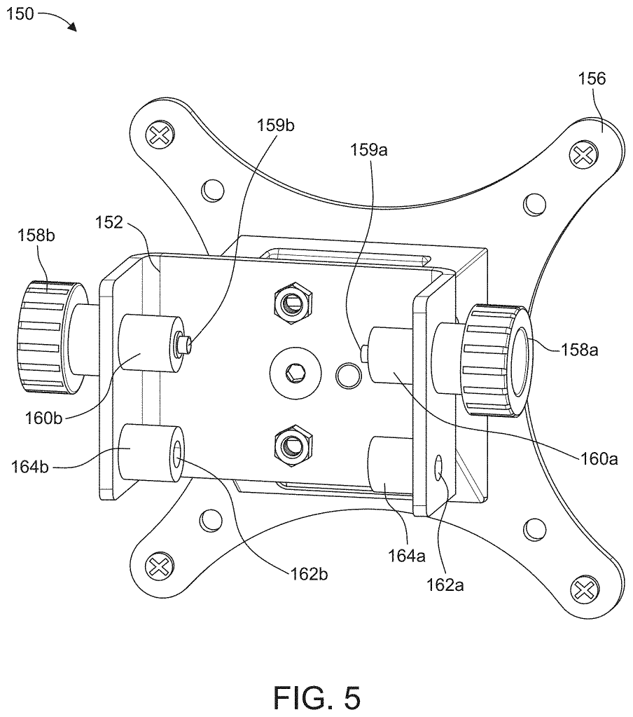

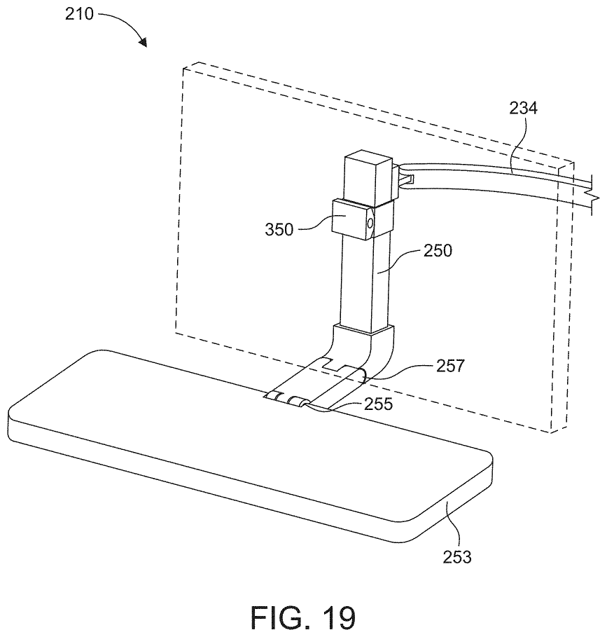

In this embodiment, the tilter 154 is attached to the column 50 via an attachment bracket 152 that is clamped within the attachment slots 54a,54b located in the column 50. Specifically, as shown in FIGS. 4 and 5, a pair of knobs 158a,158b each having a respective threaded shaft 159a,159b and being surrounded by a respective bushing 160a,160b are fit within a respective one of the attachment slots 54a,54b, along with an additional set of bushings 164a,164b that are each held in place by a respective dowel pin 162a,162b. The knobs 158a,158b are tightened against the inner surfaces of the attachment slots 54a,54b to fix a position of the display support assembly 150 along the height 52 of the column, or loosened so that a position of the display support assembly 150 along the height 52 of the column 50 may be adjusted by the user. This height adjustability is useful to allow the device support 10 to be comfortably used by users of different heights, and also to allow for adjustment of an ergonomic “elbow-to-height” spacing (i.e., vertical distance) in instances where a worksurface or additional item might also be supported from the column 50 (for example, as in the embodiment of FIGS. 18A-18C and 19).

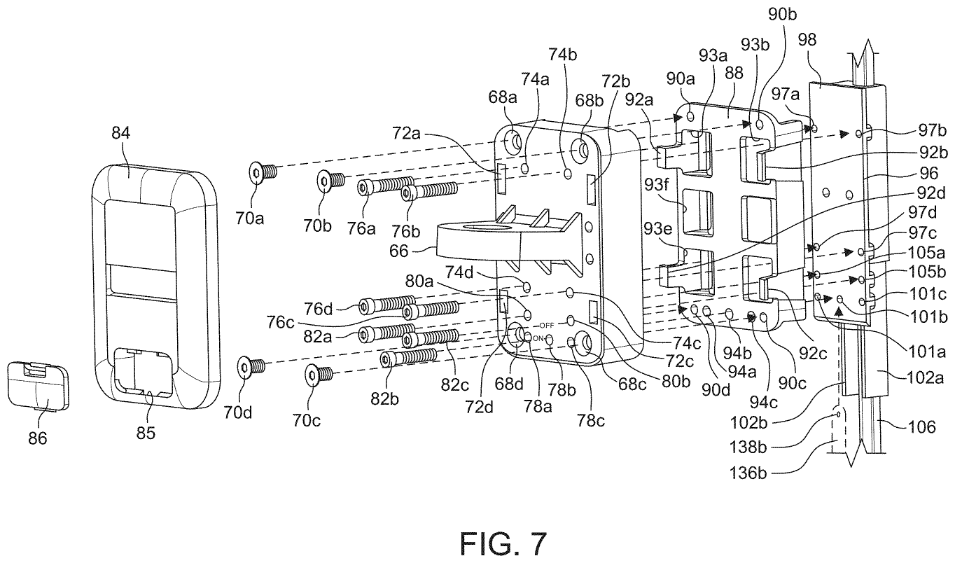

Referring now to FIGS. 6 and 7, the connection between the arm portion 20 and lift portion 44 will now be described in further detail. In this embodiment, a rear side of the column 50 further comprises three slots 56a,56b,56c running along the height 52 of the column 50. As will be described in further detail below, the carriage 64 engages a brake block 96 located interior to the column 50 through these slots 56a,56b,56c to permit height movement of the column 50 with respect to the carriage 64. In an assembled configuration, a rear side of the carriage 64 is covered by a carriage cover 84 in which an opening 85 is provided so that spring adjustments can be made to allow the lift portion 44 to accommodate different ranges of mass, as will be described in greater detail below. In this embodiment, the opening 85 is covered by a removable door 86 for aesthetic purposes.

In the partial exploded view of FIG. 7, the column 50 has been hidden from view so that the connections between the carriage 64 and the brake block 96 may be better illustrated and explained. In this embodiment, a glide plate 88 is fixedly attached to the carriage 64 using mounting tabs 92a-92d connected, respectively, to tab holes 72a-72d, in addition to fasteners 70a-70d being passed through respective holes 68a-68d in the carriage 64 and into respective holes 90a-90d located in the glide plate 88. In this embodiment, the glide plate 88 is comprised of acetal resin. In alternative embodiments, suitable alternative materials for low friction applications may be used, as would be appreciated by one of ordinary skill in the art.

Fasteners 76a-76d are routed through respective holes 74a-74d in the carriage 64, through respective passthrough spaces 93a-93f located in the glide plate 88, through a respective one of the slots 56a,56c located in the column 50, and into respective holes 97a-97d located in a mount plate 98 portion of the brake block 96. Three additional fasteners 82a-82c are used for connecting the carriage 64 and brake block 96 to either one, two, or three negator springs 136a-136c located in a handle assembly 124 which is located, in this embodiment, at a bottom end of the lift portion 44 for accommodation of different ranges of masses that might be attached to the column 50. As explained below, in this embodiment the one or more negator springs 136a-136c are attached between the carriage 64 and the column 50 (via handle assembly 124).

In this embodiment, fastener 82b and negator spring 136b are always in use. Fastener 82b is routed through “on” hole 78b in carriage 64, through “on” hole 94b located in glide plate 88, through slot 56b located in the rear side of the column 50, through an attachment hole 138b located in an end portion 137b of negator spring 136b, and into “on” hole 101b located in the mount plate 98 portion of the brake block 96. The remaining two fasteners 82a,82c may be alternately used in respective “on” or “off” positions, i.e., engaged with respective additional negator springs 136a,136c or not, depending on the mass of the load (e.g., display) that is attached to the column 50. In respective “on” positions, fasteners 82a,82c are routed through a respective “on” hole 78a,78c in carriage 64, through a respective “on” hole 94a,94c located in glide plate 88, through a respective slot 56a,56c located in the rear side of the column 50, through a respective attachment hole 138a,138c located in a respective end portion 137a,137c of a respective negator spring 136a,136c, and into a respective “on” hole 101a,101c located in the mount plate 98 portion of the brake block 96. In respective “off” positions, fasteners 82a,82c are routed through a respective “off” hole 80a,80b in carriage 64, through a respective passthrough space 93e,93d located in glide plate 88, through a respective slot 56a,56c located in the rear side of the column 50, and into a respective “off” hole 105a,105b located in the mount plate 98 portion of the brake block 96, bypassing any connection with the respective negator springs 136a,136c.

In this embodiment, a default position of the handle assembly 124 is adjacent to the carriage 64, and the handle assembly 124 (which houses the negator springs 136a-136c) must be placed in this position in order to adjust the “on” and “off” positions of the fasteners 82a,82c with respect to respective negator springs 136a,136c. As noted above, negator spring 136b is always engaged with carriage 64 and brake block 96, and in this embodiment is designed to counterbalance (i.e., counteract) masses of approximately 4-14 pounds (1.8-6.4 kg) that have been attached to the column 50. In this embodiment, engagement of two negator springs (i.e., by engaging either negator spring 136a or negator spring 136c) is designed to counterbalance masses of approximately 12-20 pounds (5.4-9.1 kg) of mass attached to the column 50, and engagement of all three negator springs 136a-136c is designed to counterbalance masses of approximately 20-30 pounds (9.1-13.6 kg) of mass attached to the column 50. In alternative embodiments, the lift portion 44 could be designed to accommodate different ranges of masses by engagement of one, two, or three of the negator springs (e.g., by using negator springs of different counterweight rating), or a greater or lesser number of negator springs may be included in the lift portion 44. In further alternative embodiments, other types of springs may be used to provide the counterbalance effect.

In the embodiment shown in FIGS. 1-17, the lift portion 44 is supported by the arm portion 20, which supports the lift portion 44 at a set height position above a respective support surface, with the lift portion 44 capable of providing all of the necessary height adjustment for the device support 10 such that it may serve as a sit-stand device. In alternative embodiments according to the present disclosure, the arm portion 20 may be omitted entirely and the lift portion 44 could be attached directly to a wall, slat wall, horizontal or vertical beam, or any other structure capable of supporting the lift portion 44 above a support surface.

Further, an alternative embodiment of a height-adjustable device support 210 is disclosed in FIGS. 18A-18C and 19. In this embodiment, the device support 210 similarly includes an arm portion 220 comprising a main arm 226 and a forearm 234 attached thereto, and a lift portion comprising a column 250 attached to the arm portion 220 and a display support assembly 350 attached to the column 250. The parts described in this paragraph may be identical or at least identical in function to the respective parts described above with respect to the embodiment of FIGS. 1-17, or these parts may vary in form and/or function from those of the embodiment of FIGS. 1-17, while maintaining the spirit thereof.

In the embodiment of FIGS. 18A-18C and 19, a worksurface 253 may additionally be attached at or near a bottom end of the column 250, to convert the height-adjustable device support 210 into a sit-stand workstation capable of supporting a keyboard and other computer peripherals thereon. In this embodiment, the worksurface 253 may be angled upwardly (e.g., between approximately 1-5 degrees, and in some embodiments 3 degrees) from a pure perpendicular relationship with respect to the column 250, to compensate for sagging of the worksurface 253 due to its own mass and the mass of objects that will likely be placed thereon. The support that attaches the worksurface 253 to the column 250 may additionally comprise a hinge 255 that allows for the worksurface 253 to be folded up against a display that has been attached to the display support assembly 350, to store the worksurface 253 and clear up space on an existing support surface (e.g., an existing table or desk surface) when the device support 210 is not in use. Additionally, or alternatively, a second hinge 257 may be included on the support structure to permit the worksurface 253 to be completely collapsed against the column 250 when the device support 210 is in a partially-disassembled configuration for shipping or storage. In these alternative embodiments, the location of the handle assembly (i.e., the release mechanism that permits for movement of the column 250) may be varied as compared to the embodiment taught in FIGS. 1-17 above.

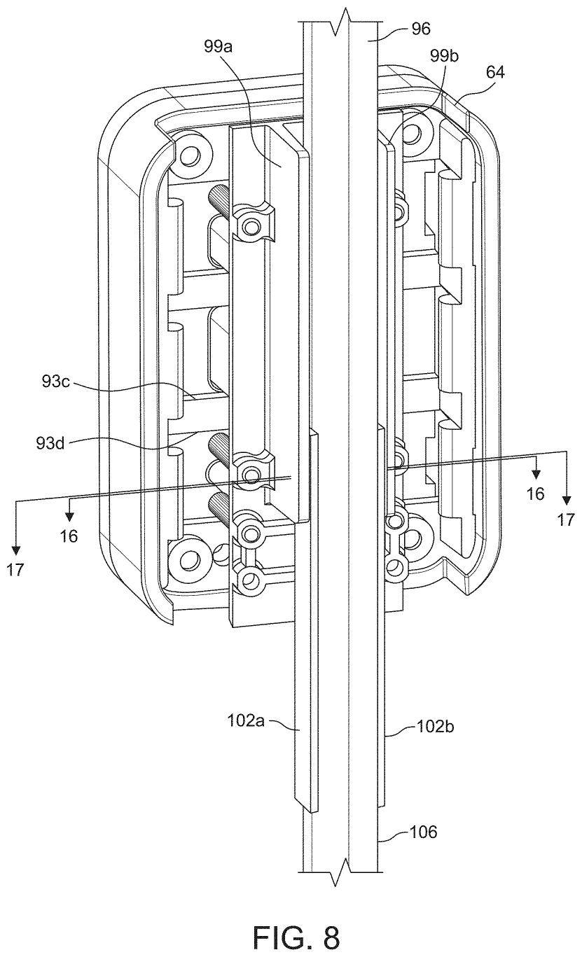

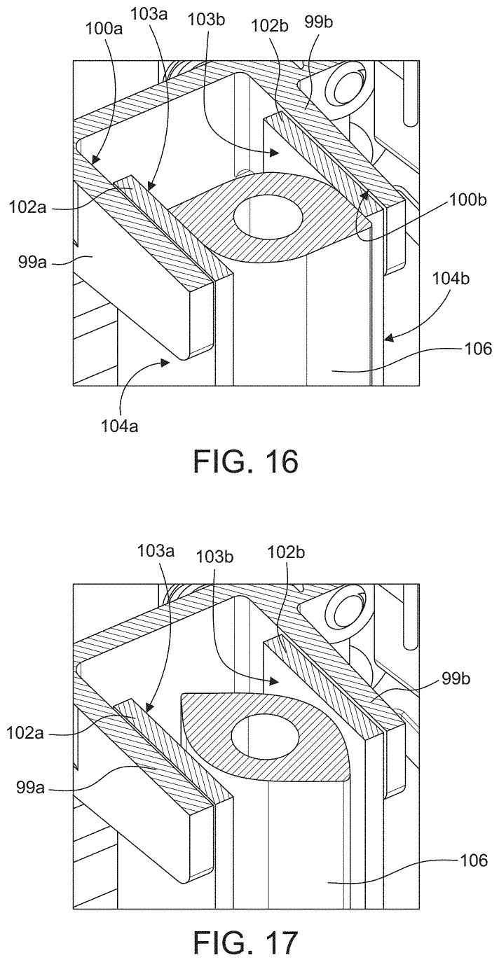

Turning back to the embodiment of FIGS. 1-17, additional components of the lift portion 44 will now be described in detail. As shown in FIG. 8, the brake block 96 further comprises a pair of wings 99a,99b extending from the mount plate 98 thereof. In this embodiment, between these wings 99a,99b a pair of brake pads 102a,102b are located, surrounding a rotatable brake cam 106 that—in this embodiment—is approximately oculiform (i.e., shaped like an eye) in cross-section. In alternative embodiments, the separate brake pads could be replaced by a single piece that is “U”-shaped in cross section and wraps around the lateral and rear sides of the brake cam 106, the two lateral sides of this single piece functioning as the two brake pad surfaces against which the brake cam 106 presses. Turning back to the present embodiment, as shown in FIG. 16, when the brake cam 106 is in its unrotated, default state, the brake cam 106 presses outwardly against interior surfaces 103a,103b of respective brake pads 102a,102b, thereby causing respective exterior surfaces 104a,104b of brake pads 102a to press into respective interior surfaces 100a,100b of the respective wings 99a,99b. The interaction of the brake cam 106, brake pads 102a,102b, and brake block 96 in this configuration (i.e., the unactuated state of the release mechanism) acts to maintain the column 50 and all objects attached thereto in a fixed height location with respect to the carriage 64, since the brake cam 106 is applying pressure against the brake block 96 in a quantity sufficient such that the height 52 of the column 50 is not adjustable with respect to the stationary vertical elevation of the carriage 64 (under normal use conditions). As shown in FIG. 17, when the brake cam 106 is in its rotated, actuated state (as further described below), the brake cam 106 is removed from contact with the interior surfaces 103a,103b of respective brake pads 102a,102b, thereby allowing the column 50 to be vertically adjusted about its height 52 with respect to the carriage 64, since the brake cam 106 is applying reduced (or zero) pressure against the brake block 96, such that the quantity of pressure sufficient to maintain the height 52 of the column 50 with respect to the stationary vertical elevation of the carriage 64 (under normal use conditions) is no longer met.

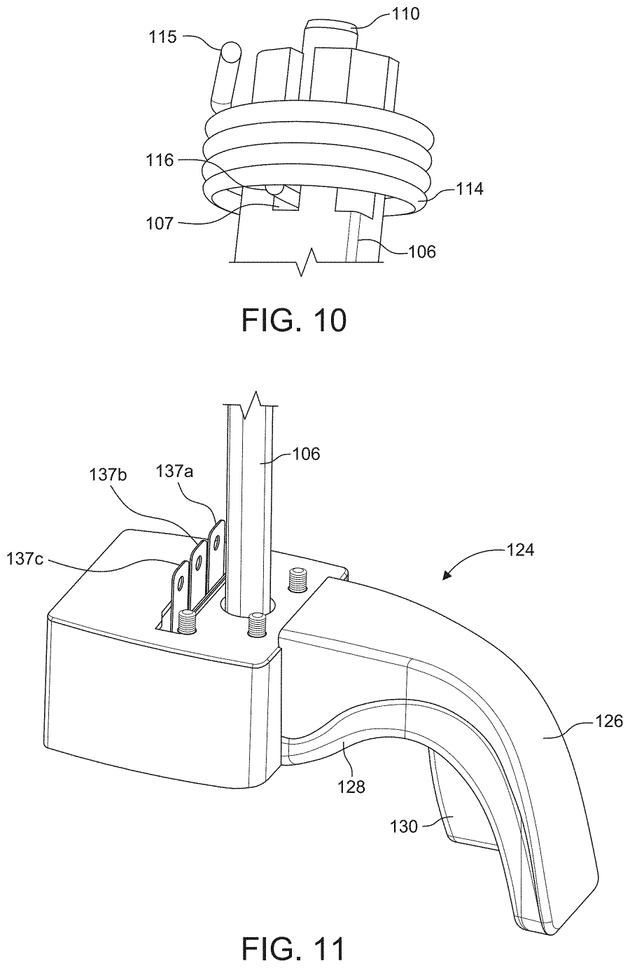

A top end of the column 50 and parts thereof are shown in FIGS. 9 and 10. In this embodiment, brake cam 106 extends to the top of the column 50, where a slot 107 located in the top end of the brake cam 106 holds a coiled spring 114 and a dowel pin 110. The dowel pin 110 is fitted within a hole 121 located in a top plate 118, which is secured to the top end of the column via fasteners 122a-122d that pass through respective fastener holes 120a-120d located in the top plate 118 and into respective holes 60a-60d in the column 50 (which in this embodiment has an extruded profile with the holes 60a-60d formed therein). The brake cam 106 rotates about the dowel pin 110 as the brake cam 106 is actuated, while the dowel pin 110 maintains the spatial positions of the brake cam 106 and coiled spring 114 within the column 50. In this embodiment, the coiled spring 114 is a torsional spring having two arms 115, 116 extending from ends thereof, with the body of the coiled spring 114 located around the brake cam 106. Arm 116 is located within slot 107 in the end of brake cam 106, with dowel pin 110 resting atop the arm 116. Arm 115 extends outwardly from the brake cam 106 and is placed into contact with an interior surface 58 of the column 50. Rotation of the brake cam 106 (in this embodiment, in a clockwise direction when the handle assembly 124 of the release mechanism is actuated) adds strain to the coiled spring 114 as the arm 115 is pressed further into the interior surface 58. Due to the inherent spring force of the coiled spring 114, the coiled spring 114 will by default attempt to counter-rotate the brake cam 106 in the opposite rotational direction (in this embodiment, counter-clockwise) to restore the brake cam 106 to its default position. The coiled spring 114 thus acts to automatically restore the brake cam 106 to its default position when the handle assembly 124 of the release mechanism is not being actuated. In this embodiment, a top cover 62 is placed atop the top end of the column 50.

With reference to FIGS. 11-15, the handle assembly 124 of the present disclosure will now be described in detail. The handle assembly 124 comprises an upper housing 126, a lower housing 128 which is fixedly attached to upper housing 126 via four fasteners (shown but not labeled in FIGS. 13-15), and a trigger 130. As explained below, the trigger 130 is part of a release mechanism that, when actuated, permits adjustment of the height 52 of the column 50 with respect to the stationary vertical elevation of the carriage 64. Brake cam 106 enters the handle assembly 124 via an opening 127 in the upper housing 126. In FIG. 11, column 50 is hidden from view for ease of discussion, but it should be understood that a bottom end of the column 50 is fixedly attached to the handle assembly 124 via fasteners 142a-142d, which are routed into respective holes located in the bottom end of the column 50.

The upper housing 126 has been removed from view in FIGS. 13-15 for ease of discussion. FIG. 13 shows the negator springs 136a-136c located within the lower housing 128, with a spring pad 140 located atop the coiled portions of the negator springs 136a-136c to prevent damage thereto. In this embodiment, as would be understood by a person having ordinary skill in the art, the negator springs 136a-136c are coiled springs that are designed with inherent spring force to naturally return to their coiled state. Thus, when connected to the carriage 64, the negator spring(s) 136b (and optionally negator springs 136a and/or 136c) pull the handle assembly upwardly (i.e., against the force of gravity), thus providing both a counterbalance effect against the mass of the items attached to the column 50, but also a “lift-assist” feature that allows for smooth adjustment of the position of the column 50 with respect to the carriage 64.

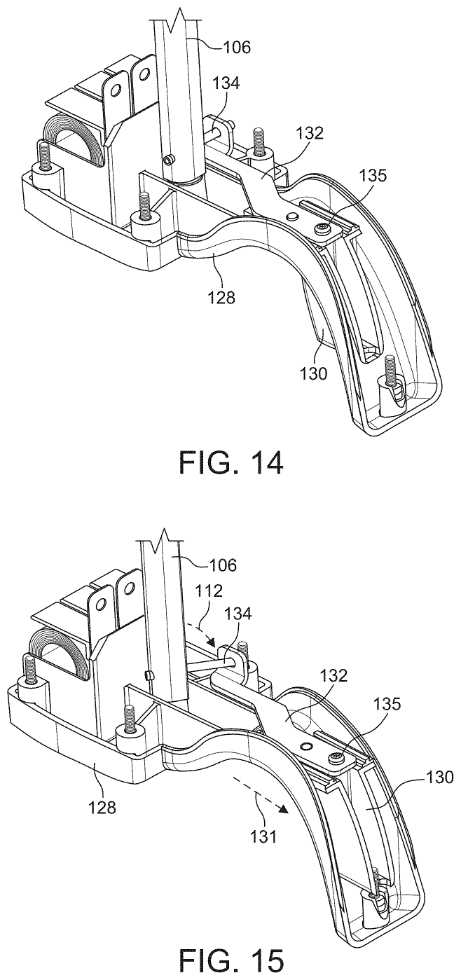

FIGS. 14 and 15 show the trigger 130 in unactuated and actuated configurations, respectively. Although not shown in the figures, the central passage hole in the bottom end of the brake cam 106 is placed within a pin that is formed as a portion of the lower housing 128, such that the brake cam 106 rotates about this pin. In this embodiment, a bottom end of the brake cam 106 includes a spring pin 134 routed therethrough. The spring pin 134 is connected with a trigger plate 132, which is attached to the trigger 130 in part by a fastener 135. When the release mechanism is actuated by depressing the trigger 130 in direction 131 shown in FIG. 15, the trigger plate 132 is pulled forwardly (i.e., in direction 131), thus pulling the attached spring pin 134 forwardly and causing the brake cam 106 to rotate in direction 112 shown in FIG. 15 about the pin in the lower housing 128. This causes the brake cam 106 to be placed in its rotational position as shown in FIG. 17, thus allowing the column 50 to be adjusted with respect to the carriage 64. In this embodiment, full actuation of the trigger 130 causes the brake cam 106 to rotate approximately 90 degrees (in this embodiment, in a clockwise direction), although greater or lesser degrees of rotation could achieve suitable freeing of the brake cam 106, as discussed above. As described above, when the trigger 130 is released, the brake cam 106 is counter-rotated back to its original rotational position by the coiled spring 114, thus arresting movement of the column 50 with respect to the carriage 64.

While the principles of the present disclosure have been described above in connection with preferred embodiments, it is to be clearly understood that this description is made only by way of example and not as a limitation of the scope of the disclosure or the invention claimed herein.

1. A height-adjustable device support comprising:
a lift portion, the lift portion including
a carriage adapted to be supported from a support surface at a stationary vertical elevation with respect to the support surface;
a column attached to the carriage, the column having a height;
at least one display support assembly attached to the column; and
a release mechanism having an actuated state and an unactuated state,
wherein when the release mechanism is in its unactuated state the height of the column is not adjustable with respect to the stationary vertical elevation of the carriage, and
wherein when the release mechanism is in its actuated state at least a portion of the height of the column is adjustable with respect to the stationary vertical elevation of the carriage.

2. The height-adjustable device support of claim 1, further comprising a brake block fixedly attached to the carriage, the brake block located at least partially interior to the column, the lift portion further comprising a brake cam and at least one brake pad, wherein when the release mechanism is in its unactuated state, the brake cam presses against the at least one brake pad and the at least one brake pad presses against the brake block such that the height of the column is not adjustable with respect to the stationary vertical elevation of the carriage, and wherein when the release mechanism is in its actuated state the brake cam does not press against the at least one brake pad or the brake block such that at least a portion of the height of the column is adjustable with respect to the stationary vertical elevation of the carriage.

3. The height-adjustable device support of claim 2, wherein the brake cam rotates within the column when the release mechanism is changed between its actuated and unactuated states.

4. The height-adjustable device support of claim 2, wherein when the release mechanism is not being maintained in its actuated state, the brake cam automatically returns to a position in which it presses against the at least one brake pad and the brake block such that the height of the column is not adjustable with respect to the stationary vertical elevation of the carriage.

5. The height-adjustable device support of claim 4, the lift assembly further comprising a spring, wherein when the release mechanism is not being maintained in its actuated state, the spring applies pressure to the brake cam to automatically return the brake cam to the position in which it presses against the at least one brake pad and the at least one brake pad presses against the brake block such that the height of the column is not adjustable with respect to the stationary vertical elevation of the carriage.

6. The height-adjustable device support of claim 5, wherein the brake cam rotates within the column when the release mechanism is changed between its actuated and unactuated states.

7. The height-adjustable device support of claim 1, further comprising at least one spring attached between the carriage and the column, the at least one spring adapted to counteract the mass of an object that is attached to the at least one display support assembly.

8. The height-adjustable device support of claim 1, wherein the release mechanism is at least partially located within a handle assembly that is located at one end of the height of the column.

9. The height-adjustable device support of claim 1, wherein the at least one display support assembly is height-adjustable along the height of the column.

10. The height-adjustable device support of claim 1, further comprising an arm portion attached to the carriage, the arm portion adapted to support the lift portion from the support surface.

11. The height-adjustable device support of claim 10, wherein the arm portion is not vertically height-adjustable.

12. The height-adjustable device support of claim 11, wherein the arm portion includes at least one generally-vertical axis of rotation.

13. The height-adjustable device support of claim 1, further comprising a worksurface attached to the column, wherein a distance between the worksurface and the at least one display support assembly along the height of the column is adjustable.

14. A height-adjustable device support comprising:
a carriage, the carriage being attachable to a support surface at a stationary vertical elevation with respect to the support surface;
a column that is slidably attached to the carriage, the column having a height;
a brake block fixedly attached to the carriage and located at least partially within the column;
a brake cam located at least partially within the column; and
a release mechanism having an actuated state and an unactuated state,
wherein when the release mechanism is in its unactuated state the brake cam applies pressure against the brake block in a quantity sufficient such that the height of the column is not adjustable with respect to the stationary vertical elevation of the carriage, and
wherein when the release mechanism is in its actuated state the brake cam applies reduced or zero pressure against the brake block, such that at least a portion of the height of the column is adjustable with respect to the stationary vertical elevation of the carriage.

15. The height-adjustable device support of claim 14, wherein the brake cam rotates within the column when the release mechanism is changed between its actuated and unactuated states.

16. The height-adjustable device support of claim 14, further comprising at least one display support assembly attached to the column.

17. The height-adjustable device support of claim 16, wherein the at least one display support assembly is height-adjustable along the height of the column.

18. The height-adjustable device support of claim 14, further comprising an arm portion attached to the carriage, the arm portion adapted to support the lift portion from the support surface.

19. The height-adjustable device support of claim 18, wherein the arm portion is not height-adjustable.

20. A height-adjustable device support comprising:
an arm portion, the arm portion having a first end and a second end located opposite the first end, wherein the vertical elevation between the first end and the second end is fixed; and
a lift portion, the lift portion including
a carriage that is fixedly attached to the second end of the arm portion at a stationary vertical elevation with respect to the first end of the arm portion;
a column attached to the carriage, the column having a height;
at least one display support assembly attached to the column; and
a release mechanism having an actuated state and an unactuated state,
wherein when the release mechanism is in its unactuated state the height of the column is not adjustable with respect to the stationary vertical elevation of the carriage, and
wherein when the release mechanism is in its actuated state at least a portion of the height of the column is adjustable with respect to the stationary vertical elevation of the carriage.
